(19) United States
(12) Patent Application Publication
(10) Pub. No.: US 2015/0348470 A1
(43) Pub. Date: Dec. 3, 2015

(54) PIXEL STRUCTURE, DISPLAY DEVICE AND DRIVING METHOD

(71) Applicant: BOE TECHNOLOGY GROUP CO., LTD., Beijing (CN)

(72) Inventors: Hongli WANG, Beijing (CN); Renwei GUO, Beijing (CN)

(73) Assignee: BOE TECHNOLOGY GROUP CO., LTD., Beijing (CN)

(21) Appl. No.: 14/442,308

(22) PCT Filed: Sep. 29, 2014
(86) PCT No.: PCT/CN2014/087810

§ 371 Date: May 12, 2015

(30) Foreign Application Priority Data
May 30, 2014 (CN) 201410240927.2

(51) Int. Cl. G09G 3/34; G02B 5/20; G09G 3/20

(52) U.S. Cl. CPC G09G 3/3413; G09G 3/2003; G02B 5/201; G09G 2340/0457; G09G 2300/0452

(57) ABSTRACT

The present disclosure provides a pixel structure, a display device and a driving method. The pixel structure includes a plurality of pixel units, each pixel unit includes at least three subpixel units in three colors, and the subpixel units are combined to form a hexagonal pixel unit. Each edge of the pixel unit is adjoined to an edge of the adjacent pixel unit except for the pixel units at a periphery of the pixel structure. According to the present disclosure, the pixel units are arranged sequentially on a display panel. As compared with an arrangement mode of the pixel structure in the related art, the pixel units in the pixel structure of the present disclosure are arranged in a more compact manner, and thereby improving a resolution as well as color distribution of the display device.

### CROSS-REFERENCE TO RELATED APPLICATION

The present application claims a priority of the Chinese patent application No. 201410240927.2 filed on May 30, 2014, which is incorporated herein by reference in its entirety.

### TECHNICAL FIELD

The present disclosure relates to the field of display technology, in particular to a pixel structure, a display device and a driving method.

### BACKGROUND

In a color display panel of the related art, a pixel unit usually includes red (R), green (G) and blue (B) subpixels; and a color and a brightness value of a pixel point may be controlled by controlling RGB color components corresponding to three subpixels in the pixel unit. FIGS. 1a-1c are schematic views showing arrangement modes of the pixel units in a display panel 10 of the related art. In a first arrangement mode as shown in FIG. 1a, RGB subpixels are arranged sequentially in a row, and the R subpixels, the G subpixels and the B subpixels are arranged in columns, respectively. In this arrangement mode, there merely exist the subpixels of one color in a vertical direction, so such a phenomenon as uneven color distribution will readily occur. As a result, a color edge error will occur and a display effect will be adversely affected. In the arrangement modes in FIGS. 1b and 1c, the uneven color distribution may also occur in some directions, and meanwhile the resolution thereof is low.

In addition, for an active matrix organic light-emitting diode (AMOLED), usually, subpixels consisting of red light-emitting layers, green light-emitting layers and blue light-emitting layers are arranged in the above-mentioned modes of the related art, so as to mix the colors, thereby to achieve full color display. Resolution and contrast are important factors for the display quality, but due to limitations of processes for forming organic layers, the improvement in the resolution of the organic light-emitting display device has run into a bottleneck. Hence, there is a need to provide a new pixel arrangement mode capable of being realized by an existing process, improving the resolution and reducing the production cost.

### SUMMARY

An object of the technical solution of the present disclosure is to provide a pixel structure, a display device and a driving method, so as to prevent the occurrence of uneven color distribution as well as a low resolution caused by the pixel arrangement mode in the related art.

The present disclosure provides a pixel structure including a plurality of pixel units, wherein each pixel unit includes at least three subpixel units in three colors, and the subpixel units are combined to form a hexagonal pixel unit; each edge of each pixel unit is adjoined to an edge of an adjacent pixel unit except for the pixel units at a periphery of the pixel structure.

Alternatively, each of the three subpixel units is of a quadrilateral shape; a first edge of a first subpixel unit is adjoined to a first edge of a second subpixel unit; a second edge of the first subpixel is adjoined to a first edge of a third subpixel unit; a second edge of the second subpixel unit is adjoined to a second edge of the third subpixel unit; wherein a third edge and a fourth edge of the first subpixel unit, a third edge and a fourth edge of the second subpixel unit, and a third edge and a fourth edge of the third subpixel unit are configured in an end-to-end manner and serve as six edges of the hexagonal pixel unit.

Alternatively, the three subpixel units each are of a diamond shape of equal edge length, and the three subpixel units are combined to form the pixel unit of a regularly hexagonal shape.

Alternatively, a minor-axis direction of the diamond shape defined by the first subpixel unit is a first direction; a minor-axis direction of the diamond shape defined by the second subpixel unit is a direction angled counterclockwise at 120° relative to the first direction; and a minor-axis direction of the diamond shape defined by the third subpixel unit is a direction angled clockwise at 120° relative to the first direction.

Alternatively, the first direction is a horizontal or vertical direction.

Alternatively, two pairs of opposite angles of each of the diamond shapes defined by the three subpixel units are 120° and 60°, respectively.

Alternatively, the three subpixel units are arranged in an identical manner in each pixel unit.

Alternatively, in two adjacent pixel units, the three subpixel units in one pixel unit are arranged in a manner identical to those in another pixel unit after the another pixel unit is rotated counterclockwise or clockwise by 120°.

Alternatively, in adjacent pixel units, the subpixel units in an identical color are nonadjacent to each other.

Alternatively, each pixel unit includes at least red, green and blue subpixel units.

Alternatively, the pixel structure includes at least two kinds of pixel units; at least one subpixel unit included in one of the two kinds of pixel units has a color different from colors of subpixel unit included in another one of the two kinds of pixel units.

The present disclosure further provides a display device including the above-mentioned pixel structure.

The present disclosure further provides a method for driving the above-mentioned display device, including: taking a polygonal region, which is defined by connection lines connecting centers of subpixel units of an identical color in a first pixel unit and at least two pixel units each adjoined to one of six edges of the first pixel unit, as a basic sampling region, and inputting a driving signal into subpixel units of the identical color at the basic sampling region, to display a corresponding color at the basic sampling region.

Alternatively, when the three subpixel units are arranged in each pixel unit in an identical manner, the method further includes: taking a triangular region, which is defined by connection lines connecting centers of the subpixel units of an identical color in the first pixel unit and two pixel units each adjoined to one of the six edges of the first pixel unit, as the basic sampling region; or taking a parallelogram region, which is defined by connection lines connecting centers of the subpixel units of an identical color in the first pixel unit and three pixel units each adjoined to one of the six edges of the first pixel unit, as the basic sampling region.

Alternatively, the basic sampling regions for an identical color are continuous in the pixel structure.

Alternatively, the step of inputting the driving signal into the subpixel units of an identical color at the basic sampling region includes: calculating a display grayscale corresponding to each subpixel unit in a to-be-displayed image at a vertex of the basic sampling region; and turning on an input circuit for each subpixel unit at the vertex of the basic sampling region, so as to display a corresponding color at the calculated display grayscale corresponding to each subpixel unit.

Alternatively, the step of calculating the display grayscale corresponding to each subpixel unit in the to-be-displayed image at the vertex of the basic sampling region includes: determining a position and a predetermined display grayscale of a predetermined point for displaying the color in the to-be-displayed image at the basic sampling region, and performing weighted calculation on the display grayscale corresponding to each subpixel unit in accordance with positional relationship between each subpixel unit at the vertex of the basic sampling region and the predetermined point, so as to enable the predetermined point in the to-be-displayed image to display the color at the predetermined display grayscale when each subpixel unit at the vertex of the basic sampling region displays the color at the corresponding display grayscale.

At least one of the above technical solutions of the embodiments of the present disclosure has following beneficial effects.

The pixel structure includes a plurality of hexagonal pixel units, and each edge of the pixel unit is adjoined to an edge of the adjacent pixel unit, so that the pixel units are arranged sequentially on a display panel (display device). As compared with an arrangement mode of the pixel structure in the related art, the pixel units in the pixel structure of the present disclosure are arranged in a more compact manner, and thereby improving a resolution as well as color distribution of the display device. In addition, through a virtual display method, a visual resolution may be further improved.

### BRIEF DESCRIPTION OF THE DRAWINGS

FIGS. 1a-1c are schematic views showing arrangement modes of pixel units in the related art;

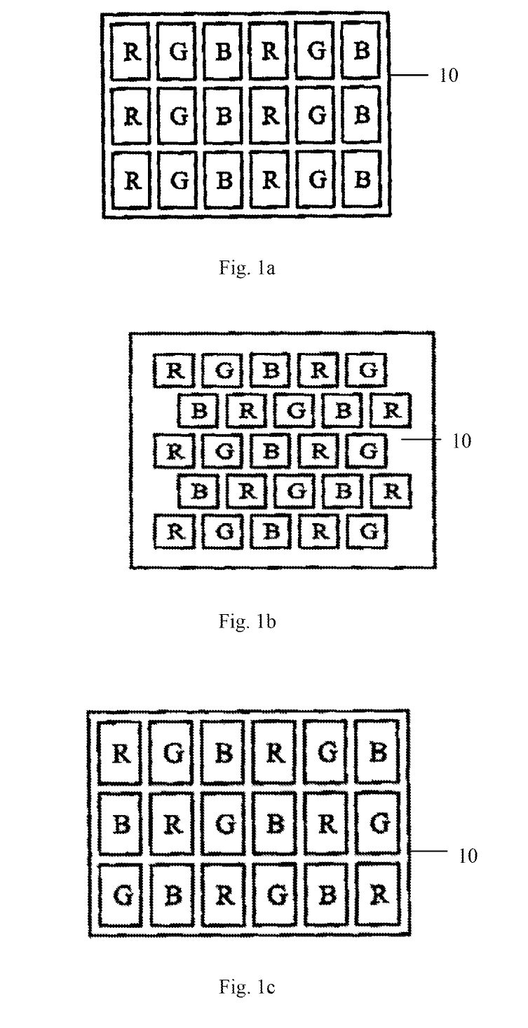

FIG. 2 is a schematic view showing pixel units in a pixel structure according to one embodiment of the present disclosure;

FIG. 3 is a schematic view showing a pixel unit in a pixel structure according to a first embodiment of the present disclosure;

FIG. 4 is a schematic view showing a pixel structure according to a second embodiment of the present disclosure;

FIG. 5 is a schematic view showing a pixel structure according to a third embodiment of the present disclosure;

FIG. 6 is a schematic view showing a pixel structure according to a fourth embodiment of the present disclosure;

FIGS. 7a-7d are schematic views showing a basic sampling region for B subpixel units when adopting a driving method according to one embodiment of the present disclosure;

FIGS. 8a-8d are schematic views showing a basic sampling region for G subpixel units when adopting the driving method according to one embodiment of the present disclosure;

FIGS. 9a-9d are schematic views showing a basic sampling region for R subpixel units when adopting the driving method according to one embodiment of the present disclosure;

FIG. 10 is a schematic view showing a situation where the basic sampling regions for the R, G and B subpixel units are superimposed; and

FIG. 11 is a schematic view showing an arrangement structure of the subpixel units in the pixel unit according to one embodiment of the present disclosure.

### DETAILED DESCRIPTION

The embodiments of the present disclosure will be described hereinafter in conjunction with the drawings.

The present disclosure provides in one embodiment a pixel structure including a plurality of pixel units. Each pixel unit includes at least three subpixel units in three colors, and the subpixel units are combined to form a hexagonal pixel unit. Except for the pixel units at a periphery of the pixel structure, six edges of each pixel unit are adjoined to edges of six adjacent pixel units, respectively.

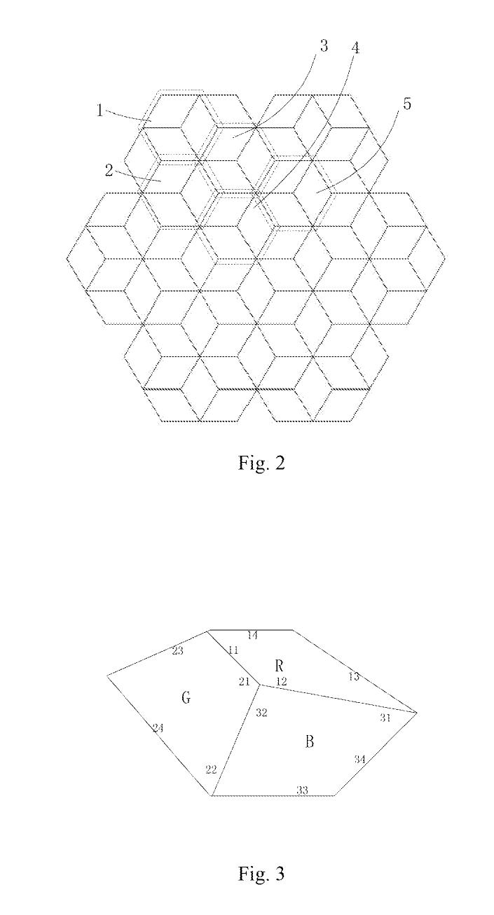

As shown in FIG. 2, the pixel structure in one embodiment of the present disclosure includes a plurality of hexagonal pixel units, e.g., pixel units 1, 2, 3, 4 and 5 represented by dotted boxes in FIG. 2. Edges of each pixel unit are adjoined to edges of different pixel units, respectively, so that the pixel units are arranged sequentially on a display panel. As compared with an arrangement mode of the pixel structure in the related art, according to one embodiment of the present disclosure, the pixel units are arranged in the pixel structure in a more compact manner, thereby improving a resolution as well as color distribution of the display device.

In one embodiment of the present disclosure, each pixel unit includes at least subpixel units in the colors R, G and B. Colors of subpixel units included in each pixel unit may be identical to colors of subpixel units included in any other pixel unit.

In addition, it should be appreciated that, in the pixel structure, colors of subpixel units in one pixel unit may be different from colors of subpixel units in another pixel unit. That is, one pixel unit may include the R, G and B subpixel units, and may also include subpixel units in other colors such as magenta, cyan and yellow. The subpixel units in other colors such as magenta, cyan and yellow may form one pixel unit, or may also form one pixel unit in combination with at least one of the R, G and B subpixel units. In a word, the subpixel units included in the pixel units may be in various colors or in different color combinations. Correspondingly, the pixel structure may include different pixel units with different color combinations, depending on requirements on color display and different display requirements.

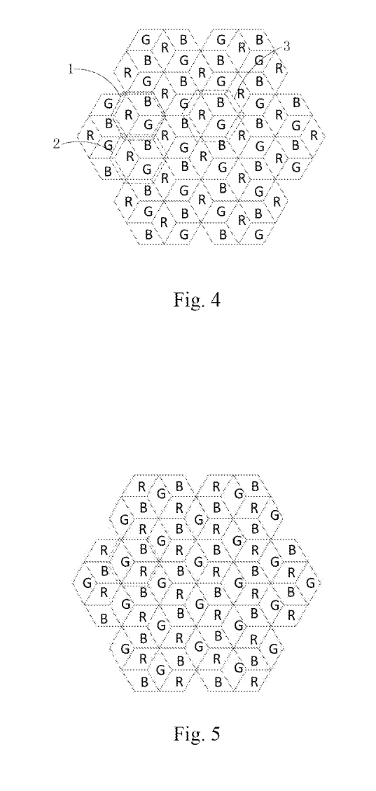

In the first embodiment of the present disclosure, in each pixel unit, the three subpixel units each are of an irregular quadrilateral shape. As shown in FIG. 3 in conjunction with FIG. 2, a first edge 11 of a first subpixel unit (e.g., R subpixel unit) is adjoined to a first edge 21 of a second subpixel unit (e.g., G subpixel unit); a second edge 12 of the first subpixel unit is adjoined to a first edge 31 of a third subpixel unit (e.g., B subpixel unit); and a second edge 22 of the second subpixel unit is adjoined to a second edge 32 of the third subpixel unit.

In the first subpixel unit, the second subpixel unit and the third subpixel unit, the first edges are adjoined to the second edges, respectively. A third edge 13 and a fourth edge 14 of the first subpixel unit, a third edge 23 and a fourth edge 24 of the second subpixel unit, and a third edge 33 and a fourth edge 34 of the third subpixel unit are configured in an end-to-end manner and serve as six edges of the hexagonal pixel unit.

In other words, through the structure as shown in FIG. 3, the R, G and B subpixel units of quadrilateral shapes are combined in such a manner that any two of them are adjoined to each other to form the hexagonal pixel unit.

In addition, in various pixel units, the R, G and B subpixel units may be arranged in an identical mode or in different modes. For example, in two adjacent pixel units, the three subpixel units in one pixel unit are arranged in a manner identical to those in another pixel unit after the another pixel unit is rotated counterclockwise or clockwise by 120°, and the subpixel units in an identical color are nonadjacent to each other. Alternatively, in order to simplify a manufacturing process, the R, G and B subpixel units in the various pixel units are provided with an identical structure and arranged in an identical manner.

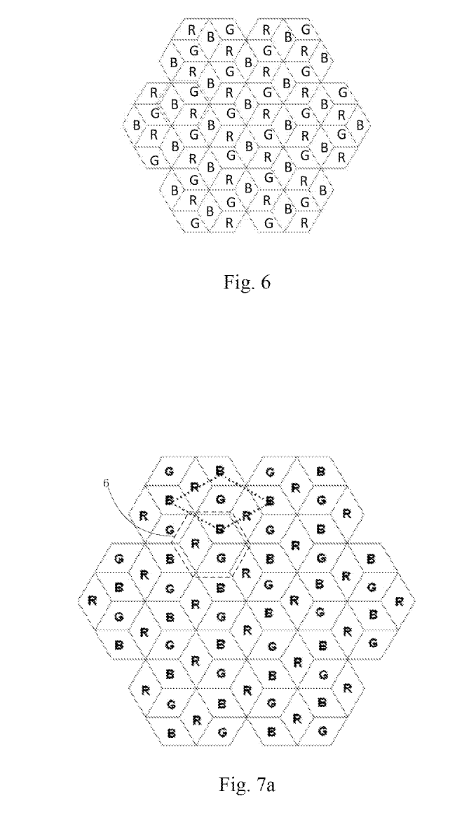

FIG. 4 is a schematic view showing the pixel structure according to the second embodiment of the present disclosure. In the second embodiment, the R, G and B subpixel units each are of a diamond shape. The R and G subpixel units share a common edge, the R and B subpixel units share a common edge, the B and G subpixel units share a common edge. The three subpixel units are combined to form a regular hexagonal pixel unit, and six edges of the pixel unit are adjoined to six different pixel units, respectively, so as to form the compact pixel structure.

In addition, in the second embodiment, the three diamond shapes defined by the R, G and B subpixel units are of an identical shape with two pairs of opposite angles of 120° and 60°, respectively. Further, the R, G and B subpixel units are arranged in the pixel units in an identical manner.

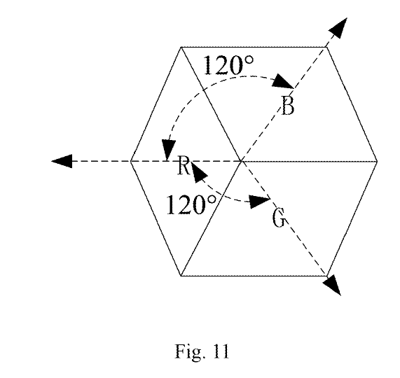

As shown in FIG. 4 in conjunction with FIG. 11, in each pixel unit, a minor-axis direction of the diamond shape defined by the R subpixel unit is a horizontal direction (a first direction); a minor-axis direction of the diamond shape defined by the G subpixel unit is a direction angled counterclockwise at 120° relative to the horizontal direction; and a minor-axis direction of the diamond shape defined by the B subpixel unit is a direction angled clockwise at 120° relative to the horizontal direction. In addition, a major-axis direction of the diamond shape defined by each of the R, G and B subpixel units is perpendicular to the minor-axis direction of the diamond shape defined by each of the R, G and B subpixel units.

The above mentioned major-axis direction refers to an extension direction of a longer one of two diagonal lines of the diamond-shaped subpixel unit, while the minor-axis direction refers to an extension direction of a shorter one of the two diagonal lines of the diamond-shaped subpixel unit. Referring to FIG. 4, when the R, G and B subpixel units are arranged in the above-mentioned manner, the regularly hexagonal pixel unit includes three pairs of opposite edges parallel to each other, and one pair of the opposite edges may be arranged horizontally or vertically. In this embodiment, one pair of the opposite edges are arranged horizontally. When the hexagonal pixel units are arranged sequentially and the six edges of each pixel unit are adjoined to six different pixel units except for the pixel units at the edge of the pixel structure, a plurality of pixel units, e.g., pixel units 1 and 2 in FIG. 4, are arranged sequentially in a vertical direction to define a column; while among pixel units in the same row in the horizontal direction, pixel units of adjacent columns, e.g., pixel units 1 and 3 in FIG. 4, are spaced apart from each other at a distance which is equal to a length of one edge of the subpixel unit.

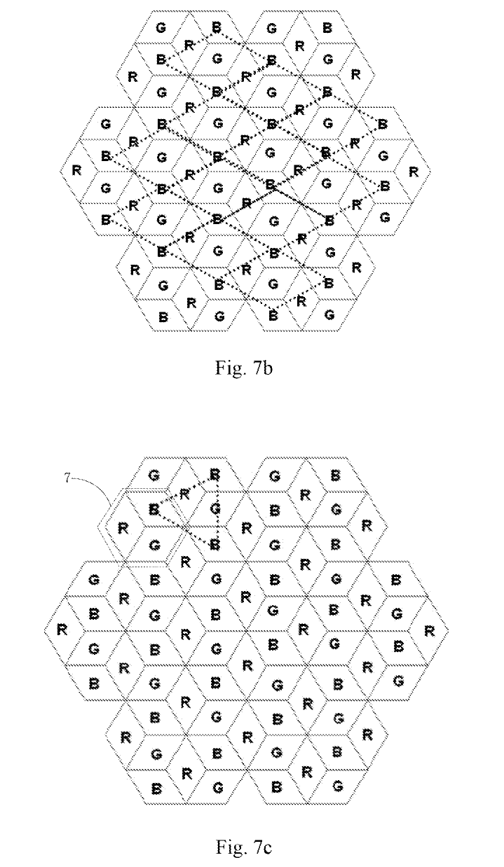

FIG. 5 is a schematic view showing the pixel structure according to the third embodiment of the present disclosure. By comparing FIG. 5 with FIG. 4, the shape of the pixel unit and the shape of the subpixel unit in the pixel unit in the third embodiment are identical to those mentioned in the second embodiment, respectively. The only difference lies in that, the R, G and B subpixel units are arranged in a different manner. In the third embodiment, the minor-axis direction of the diamond shape defined by the G subpixel unit is the horizontal direction (the first direction), the minor-axis direction of the diamond shape defined by the R subpixel unit is a direction angled counterclockwise at 120° relative to the horizontal direction; and the minor-axis direction of the diamond shape defined by the B subpixel unit is a direction angled clockwise at 120° relative to the horizontal direction.

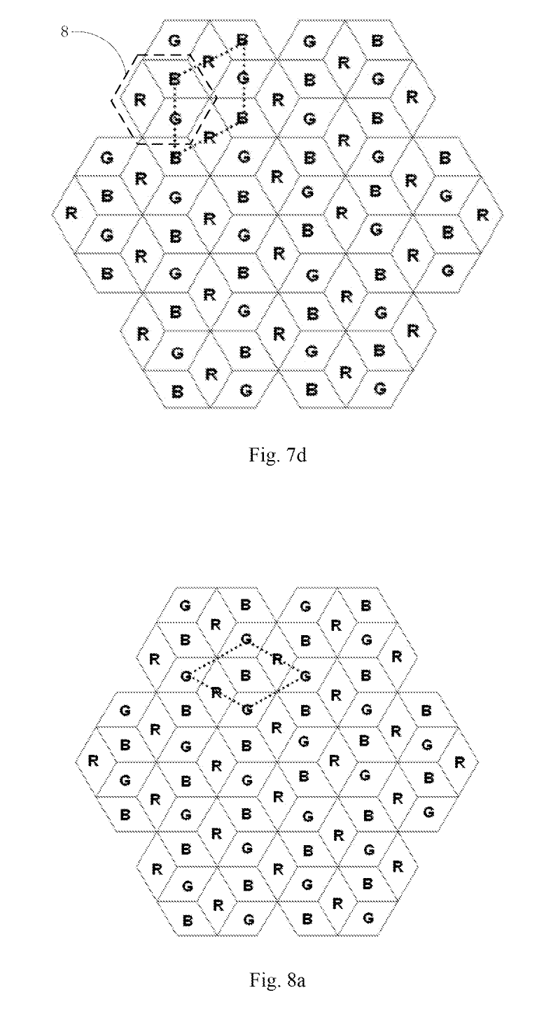

Of course, based on the pixel structures mentioned in the second and third embodiments, the arrangement mode of the R, G and B subpixel units may be further adjusted so as to form a pixel structure as shown in FIG. 6. As shown in FIG. 6, the minor-axis direction of the diamond shape defined by the B subpixel unit is the horizontal direction (the first direction); the minor-axis direction of the diamond shape defined by the R subpixel unit is a direction angled counterclockwise at 120° relative to the horizontal direction; and the minor-axis direction of the diamond shape defined by the G subpixel unit is a direction angled clockwise at 120° relative to the horizontal direction.

Of course, in the pixel structure, each pixel unit may alternatively include one subpixel unit with a major-axis direction extending in the horizontal direction and a minor-axis direction extending in the vertical direction. Then, the R, G and B subpixel units are arranged in a mode obtained through rotating FIG. 4, 5 or 6 counterclockwise or clockwise by 90°. The structural features thereof are similar to those mentioned above, and thus will not be repeated herein.

According to the pixel structure in the embodiments of the present disclosure, regardless of the structures and the arrangement modes of the R, G and B subpixel units, it is merely required to piece together every two of the three subpixel units in such a manner that the three subpixel units are combined to form the hexagonal pixel unit and the six edges of each pixel unit are adjoined to six different pixel units. According to this rule, the various pixel units may be arranged in a compact manner on a display panel. As compared with the pixel structure where the pixel units are arranged in a strip-like manner in the related art, the pixel structure in the embodiments of the present disclosure has such advantages as high contrast, high resolution and excellent color-mixing effect, thereby improving the image quality.

The present disclosure further provides in one embodiment a display device including the above-mentioned pixel structure. Based on the above description, a person skilled in the art should know elements included in the display device and the wiring design therefor, which are not research focuses and will not be particularly defined herein.

When the pixel units are arranged according to the above rule for arrangement, in one first pixel unit and at least two pixel units each adjoined to one of the six edges of the first pixel unit, a polygon may be defined by connection lines connecting centers of subpixel units in an identical color. When a driving signal is inputted into the pixel units of the display panel, the above-mentioned polygon is taken as a sampling region, and the driving signal is inputted to the subpixel units at the sampling region, so as to further improve the resolution.

The principle of inputting the signal according to the sampling region will be described hereinafter in conjunction with a method for driving the display device.

The method for driving the display device with the above-mentioned pixel structure in one embodiment of the present disclosure includes: taking a polygonal region, which is defined by connection lines connecting centers of subpixel units of an identical color in one first pixel unit and at least two pixel units each adjoined to one of six edges of the first pixel unit, as a basic sampling region, and inputting a driving signal into subpixel units of the identical color at the basic sampling region to display a corresponding color at the basic sampling region.

When the above-mentioned pixel structure is adopted, in the entire display panel (display device), a plurality of pixel units is arranged around each pixel unit. Taking the first subpixel unit as an example, a polygon is defined by the connection lines connecting the centers of subpixel units of an identical color in the first pixel unit and at least two pixel units each adjoined to one of six edges of the first pixel unit.

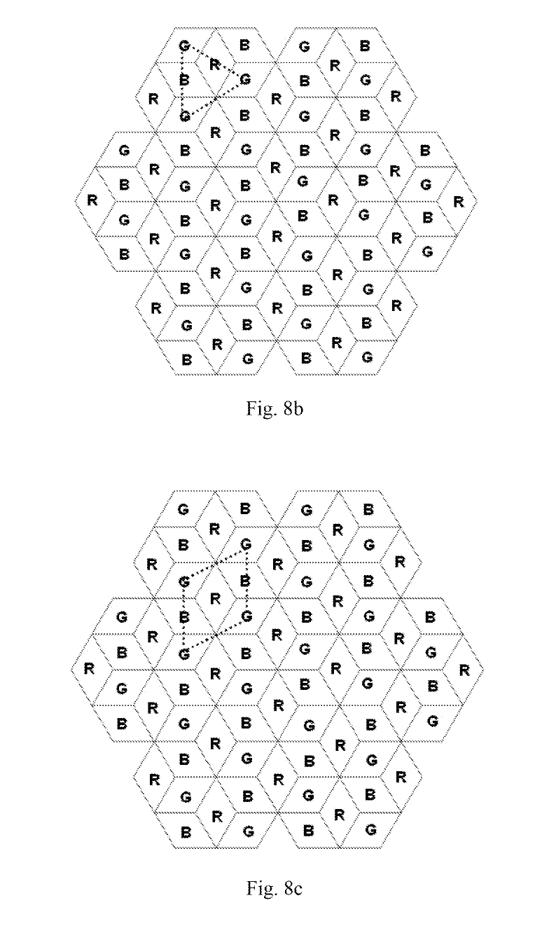

Taking the structure shown in FIG. 4 according to the second embodiment as an example, as shown in FIG. 7a, at a periphery of a first pixel unit 6, a parallelogram is defined by connection lines connecting centers of B subpixel units in the first pixel unit 6 and three pixel units adjoined to the first pixel unit 6. This parallelogram is a basic sampling region for the B subpixel units. According to the rule for defining the basic sampling region, other pixel units of the display panel may be sampled to define a plurality of continuous parallelograms as shown in FIG. 7b, thereby defining a display plane for B color.

As shown in FIG. 7c, a triangle is defined by connection lines connecting centers of B subpixel units in a first pixel unit 7 and two pixel units adjoined to the first pixel unit 7, and this triangle is a basic sampling region for the B subpixel units. Similarly, according to the rule for defining the basic sampling region, other pixel units of the display panel may be sampled to define a plurality of triangles as shown in FIG. 7c and define continuous triangular sampling regions (not shown) on the entire pixel structure, thereby defining a display plane for B color.

As shown in FIG. 7d, at a periphery of a first pixel unit 8, a parallelogram different from that in FIG. 7a is defined by connection lines connecting centers of B subpixel units in the first pixel unit 8 and three pixel units adjoined to the first pixel unit 8, and this parallelogram is a basic sampling region for the B subpixel units. Similarly, according to the rule for defining the basic sampling region, other pixel units of the display panel may be sampled to define a plurality of parallelograms each having a shape shown in FIG. 7d and define continuous parallelogram sampling regions (not shown) on the entire pixel structure, thereby defining a display plane for B color.

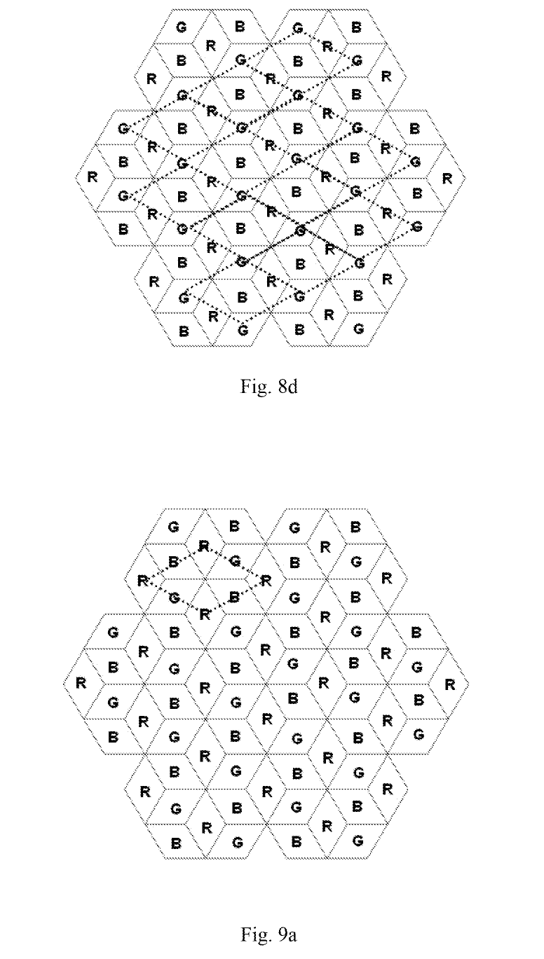

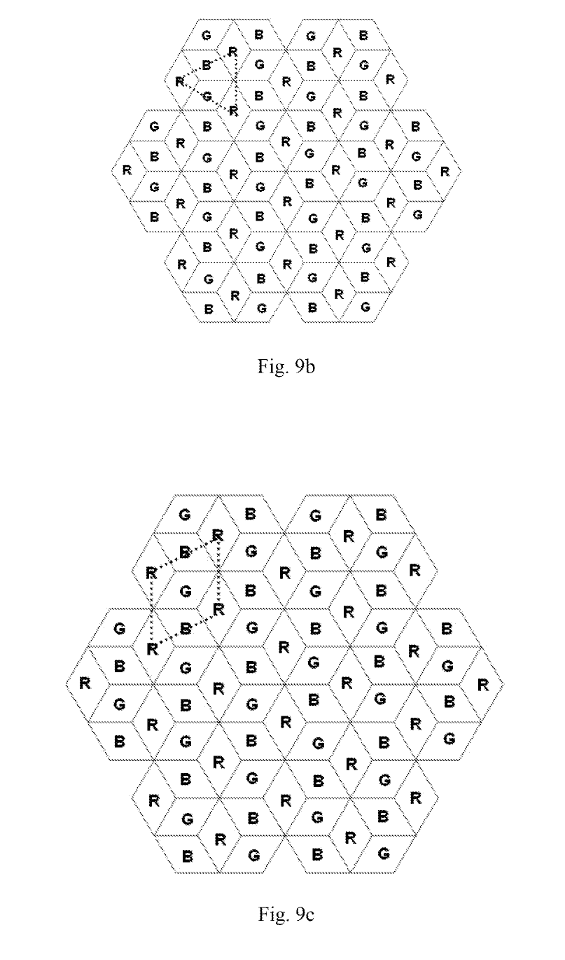

Similarly, for the G subpixel units and the R subpixel units of the pixel structure of one embodiment of the present disclosure, as shown in FIGS. 8a-8d and 9a-9d, a basic sampling region may also be defined by connection lines connecting centers of G or R subpixel units in one pixel unit and at least two subpixel units adjoined to the pixel unit. Other pixel units of the display panel may also be sampled in a similar manner to define a plurality of continuous polygons on the entire pixel structure, thereby defining a display plane for G color and a display plane for R color.

Hence, on the basis of the above-mentioned principle, when the basic sampling regions for the color R are formed by sampling the R subpixel units on the display panel according to the specific rule, a plurality of the basic sampling regions for the color R is connected together to define a display plane for the color R. When the basic sampling regions for the color G are formed by sampling the G subpixel units on the display panel according to the specific rule, a plurality of the basic sampling regions for the color G is connected together to define a display plane for the color G. When the basic sampling regions for the color B are formed by sampling the B subpixel units on the display panel according to the specific rule, a plurality of the basic sampling regions for the color B is connected together to define a display plane for the color B.

According to the driving method in the embodiment of the present disclosure, by adopting the above manner of creating the basic sampling regions, the display planes for the colors R, G and B are divided evenly in the display panel, respectively, as shown in FIGS. 7b, 8d and 9d. A driving signal is inputted into subpixel units of an identical color at one basic sampling region, so that the sampling region displays the corresponding color. For example, for the basic sampling region created for the color B in FIG. 7a, when a blue signal is inputted at the basic sampling region, a display grayscale corresponding to each subpixel unit in a to-be-displayed image at a vertex of the basic sampling region for the color B is calculated, and the B subpixel units corresponding to the four vertices of the basic sampling region of a parallelogram shape are turned on at brightness values which correspond to the calculated display grayscales corresponding to the B subpixel units, respectively. To be specific, the step of calculating the display grayscale corresponding to each subpixel unit in the to-be-displayed image at the vertex of the basic sampling region includes: determining a position and a predetermined display grayscale of a predetermined point for displaying the color, e.g., blue (B), in the to-be-displayed image at the basic sampling region, and performing weighted calculation on the display grayscale corresponding to each subpixel unit (e.g., B subpixel unit) in accordance with positional relationship between each subpixel unit at one of the vertexes of the basic sampling region and the predetermined point, so as to enable the predetermined point in the to-be-displayed image to display the color at the predetermined display grayscale when each subpixel unit at one of the vertexes of the basic sampling region displays the color at the corresponding display grayscale.

In this way, the display region is divided into a plurality of sampling regions for each color, and the display point at each sampling region displays the color at the predetermined display grayscale under co-action of the various subpixel units which form the sampling region. Meanwhile, in order to achieve continuous display of each color, the entire display region is divided into a plurality of continuous sampling regions and some subpixel units at each sampling region may be shared by several sampling regions. For example, one subpixel unit may be used to foil two sampling regions, and this subpixel unit works when either one of the two sampling regions displays the color. This refers to the so-called “common pixel”, i.e., a pixel unit, e.g., a B subpixel unit, may be used in a diversified manner, and it may be turned on or off independently of the subpixel units in other colors, e.g., the G subpixel unit and the R subpixel unit.

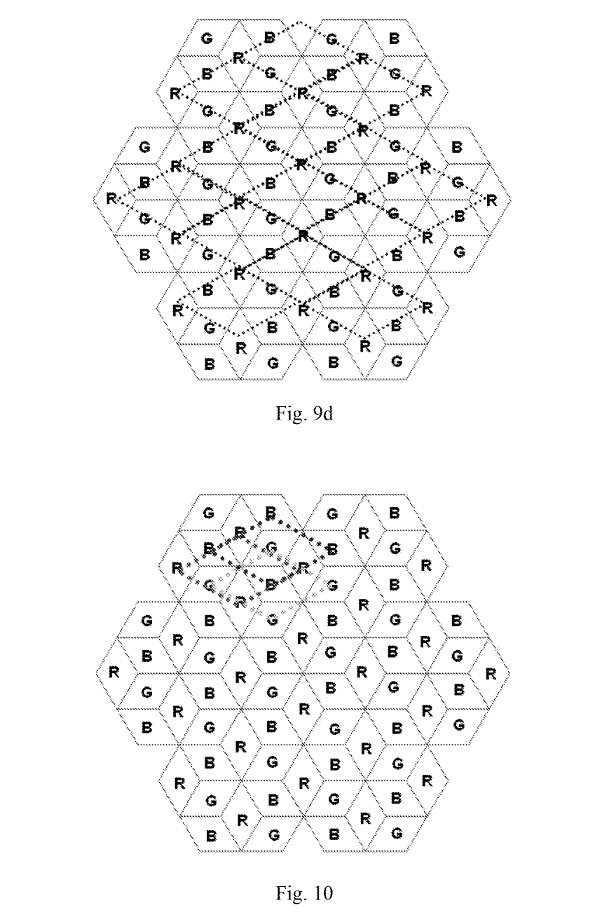

Referring to FIG. 10, when the display planes for the colors R, G and B are formed on the display panel according to the above mentioned manner, there may be overlapping portions between the basic sampling regions corresponding to the R, G and B subpixel units, respectively, thereby achieving the full color display. Since the basic sampling regions for each color are continuous, and the basic sampling regions in the display planes for different colors may be superimposed so as to achieve the full color display at the entire display region. By using the driving method in the embodiment of the present disclosure, at the superimposed basic sampling regions for the three color shown in FIG. 10, when displaying the blue color, the B subpixel units at the four vertices of the basic sampling region are turned on; when displaying the red color, the R subpixel units at the four vertices of the basic sampling region are turned on; similarly, when displaying the green color, the G subpixel units at the four vertices of the basic sampling region are turned on. The grayscale for the subpixel units at the vertices of the basic sampling region is acquired by average calculation. For example, a brightness value of the color B to be displayed at the basic sampling region is an average value of the brightness values of the four B subpixel units with minimum distances from each other in a physical space. In this way, for different color images, the color B may be differentiated within a minimum range, so as to improve the visual resolution. In addition, the sampling regions for the R, G and B subpixel units may be superimposed, and different colors may be displayed by alternative superimposition. As a result, it is able to display different colors at the superimposed region, thereby to achieve visual display.

After a single basic sampling region for each color has been determined, sampling may be performed repeatedly in the entire pixel structure according to the set rule for the basic sampling regions, so as to form regions for different colors on the entire display panel in a regular and periodical manner.

According to the driving method in the embodiment of the present disclosure, the basic sampling region is set in such a manner that a minimum area is provided. When the basic sampling region has the minimum area, it is able to provide more basic sampling regions, thereby to display the image at a higher resolution. For example, an area of the basic sampling region for the color B in FIG. 7c is less than an area of the basic sampling region for the color B in FIG. 7a.

According to the pixel structure, the display device and the driving method in the embodiments of the present disclosure, the pixel units are arranged in a more compact manner, and the colors are mixed evenly in all directions. As a result, it is able to prevent the occurrence of a color edge error and improve the resolution.

The above are merely optional embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A pixel structure, comprising a plurality of pixel units, wherein each pixel unit comprises at least three subpixel units in three colors, and the subpixel units are combined to form a hexagonal pixel unit; each edge of each pixel unit is adjoined to an edge of an adjacent pixel unit except for the pixel units at a periphery of the pixel structure.

2. The pixel structure according to claim 1, wherein each of the three subpixel units is of a quadrilateral shape; the three subpixel units comprise a first subpixel unit, a second subpixel unit and a third subpixel unit;
a first edge of the first subpixel unit is adjoined to a first edge of the second subpixel unit;
a second edge of the first subpixel is adjoined to a first edge of the third subpixel unit;
a second edge of the second subpixel unit is adjoined to a second edge of the third subpixel unit;
wherein a third edge and a fourth edge of the first subpixel unit, a third edge and a fourth edge of the second subpixel unit, and a third edge and a fourth edge of the third subpixel unit are configured in an end-to-end manner and serve as six edges of the hexagonal pixel unit.

3. The pixel structure according to claim 2, wherein the three subpixel units each are of a diamond shape of equal edge length, and the three subpixel units are combined to form the pixel unit of a regularly hexagonal shape.

4. The pixel structure according to claim 3, wherein a minor-axis direction of the diamond shape defined by the first subpixel unit is a first direction; a minor-axis direction of the diamond shape defined by the second subpixel unit is a direction angled counterclockwise at 120° relative to the first direction; and a minor-axis direction of the diamond shape defined by the third subpixel unit is a direction angled clockwise at 120° relative to the first direction.

5. The pixel structure according to claim 4, wherein the first direction is a horizontal or vertical direction.

6. The pixel structure according to claim 3, wherein two pairs of opposite angles of each of the diamond shapes defined by the three subpixel units are 120° and 60°, respectively.

7. The pixel structure according to claim 2, wherein the three subpixel units are arranged in an identical manner in each pixel unit.

8. The pixel structure according to claim 7, wherein the hexagonal shape is a regularly hexagonal shape; one pair of the opposite edges of the regularly hexagonal shape are arranged horizontally; when the hexagonal pixel units are arranged sequentially, the pixel units are arranged sequentially in a vertical direction to define a column; among pixel units in an identical row in the horizontal direction, pixel units of adjacent columns are spaced apart from each other at a distance which is equal to a length of one edge of one subpixel unit.

9. The pixel structure according to claim 1, wherein in two adjacent pixel units, the three subpixel units in one pixel unit are arranged in a manner identical to those in another pixel unit after the another pixel unit is rotated counterclockwise or clockwise by 120°.

10. The pixel structure according to claim 1, wherein in adjacent pixel units, the subpixel units in an identical color are nonadjacent to each other.

11. The pixel structure according to claim 1, wherein each pixel unit comprises at least red, green and blue subpixel units.

12. The pixel structure according to claim 1, wherein the pixel structure comprises at least two kinds of pixel units; at least one subpixel unit included in one of the two kinds of pixel units has a color different from colors of subpixel unit included in another one of the two kinds of pixel units.

13. A display device comprising the pixel structure according to claim 1.

14. A method for driving the display device according to claim 13, comprising:
taking a polygonal region, which is defined by connection lines connecting centers of subpixel units of an identical color in a first pixel unit and at least two pixel units each adjoined to one of six edges of the first pixel unit, as a basic sampling region, and inputting a driving signal into subpixel units of the identical color at the basic sampling region, to display a corresponding color at the basic sampling region.

15. The method according to claim 14, wherein when the three subpixel units are arranged in each pixel unit in an identical manner, the method further comprises:
taking a triangular region, which is defined by connection lines connecting centers of the subpixel units of an identical color in the first pixel unit and two pixel units each adjoined to one of the six edges of the first pixel unit, as the basic sampling region; or
taking a parallelogram region, which is defined by connection lines connecting centers of the subpixel units of an identical color in the first pixel unit and three pixel units each adjoined to one of the six edges of the first pixel unit, as the basic sampling region.

16. The method according to claim 15, wherein the basic sampling regions for an identical color are continuous in the pixel structure.

17. The method according to claim 14, wherein the step of inputting the driving signal into the subpixel units of an identical color at the basic sampling region comprises:
calculating a display grayscale corresponding to each subpixel unit at a vertex of the basic sampling region in a to-be-displayed image; and
turning on an input circuit for each subpixel unit at the vertex of the basic sampling region, so as to display a corresponding color at the calculated display grayscale corresponding to each subpixel unit.

18. The method according to claim 17, wherein the step of calculating the display grayscale corresponding to each subpixel unit at the vertex of the basic sampling region in the to-be-displayed image comprises:
determining a position and a predetermined display grayscale of a predetermined point for displaying the color in the to-be-displayed image at the basic sampling region, and performing weighted calculation on the display grayscale corresponding to each subpixel unit in accordance with positional relationship between each subpixel unit at the vertex of the basic sampling region and the predetermined point, so as to enable the predetermined point in the to-be-displayed image to display the color at the predetermined display grayscale when each subpixel unit at the vertex of the basic sampling region displays the color at the corresponding display grayscale.

19. The method according to claim 18, wherein the grayscale for the subpixel units at the vertices of the basic sampling region is acquired by average calculation.

20. The method according to claim 14, wherein a part of the subpixel units at each basic sampling region is shared with other basic sampling region.

21. The method according to claim 14, wherein there is an overlapping portion between the basic sampling regions.
